(19) United States
(12) Patent Application Publication
(10) Pub. No.: US 2025/0059350 A1
(43) Pub. Date: Feb. 20, 2025

(54) CROSSLINKABLE COMPOSITIONS INCLUDING A LATENT UV-ABSORBER

(71) Applicant: 3M INNOVATIVE PROPERTIES COMPANY, St. Paul, MN (US)

(72) Inventors: Hyunki Kim, Woodbury, MN (US); Karl E. Benson, St. Paul, MN (US); Jason D. Clapper, Lino Lakes (MN)

(21) Appl. No.: 18/722,212

(22) PCT Filed: Dec. 21, 2022
(86) PCT No.: PCT/IB2022/062645

§ 371 Date: Jun. 20, 2024

Related U.S. Application Data
(60) Provisional application No. 63/295,379, filed on Dec. 30, 2021.

(51) Int. Cl. C08K 5/3475; C08K 5/101; C09J 7/38; C09J 133/08

(52) U.S. Cl. CPC C08K 5/3475; C08K 5/101; C09J 7/385; C09J 133/08; C09J 2301/302; C09J 2433/00

(57) ABSTRACT

Provided are crosslinkable compositions comprising a (meth)acrylate polymer, where the polymer has a glass transition temperature no greater than 30° C.; a crosslinking agent, the crosslinking agent comprising a photo-active Type II photoinitiator and a polymerizable group selected from the group consisting of (meth)acrylate, allyl, and combinations thereof; and a UV absorbing material represented by the structure (I) where each of X¹, X², X³, and X⁴ is independently a hydrogen atom, a hydrocarbyl group including 1 to 15 carbon atoms, preferably 12 carbon atoms, or a heterohydrocarbyl group including 1 to 15 carbon atoms, preferably 12 carbon atoms.

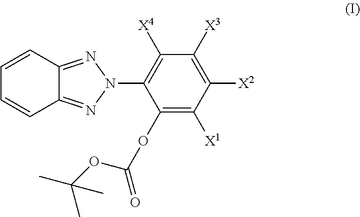

In electronic devices, e.g., electronic display devices, pressure sensitive adhesives (“PSAs”) are commonly used to bond a cover glass or lens to the underlying display module of the electronic device, bond the touch sensor to the cover glass and the display, or bond the lower components of the display to the housing. The pressure-sensitive adhesives used in these electronic devices may be optically clear adhesives (“OCAs”).

The presence of an OCA can improve the performance of a display device, for example, by increasing brightness and contrast, while also providing structural support to the assembly. For these applications (commonly referred to as electronics bonding, or e-bonding). both the PSAs and the OCAs should have sufficiently high strength of adhesive force to properly maintain good adhesion to components, not only when the electronic devices are operating under normal conditions, but also when they are subjected to traumatic forces or extreme environmental conditions.

OCAs used in optoelectronic devices to enhance light extraction efficiencies typically require high mechanical conformability for successful lamination in complex topographical surfaces. However, once the film is laminated, the OCA commonly needs to have a high degree of mechanical stability to protect the device for long periods of time with high mechanical strength. This transition of mechanical properties may be achieved by using a UV-induced curing process to be implemented after lamination. Highly flowable OCAs with high viscous properties (or high tan(delta) values) are preferred for the first lamination step. Post lamination, a UV-cure process reduces the viscous property of the OCA (evidenced by low tan(delta) values) through additional crosslinking to increase the mechanical properties.

However, this scheme becomes increasingly difficult to achieve when UV absorbers are incorporated into the OCA for additional reliability performance. While UV absorbers can protect the device from environmental UV-exposure, they may also block the necessary UV-light for the post lamination UV curing step and significantly decrease the curing efficiency. Therefore, there is a need for UV-absorbing/UV-curable OCA pathways to accomplish all features of this concept simultaneously.

In this disclosure, we provide a route to achieving a UV-blocking and UV-curing OCA by including a latent UV absorbing material in a crosslinkable composition.

Unless otherwise noted, all parts, percentages, ratios, etc. in the examples and the rest of the specification are by weight. Unless otherwise indicated, materials used in the examples were obtained from commercial suppliers (e.g., Aldrich Chemical Co., Milwaukee, Wisconsin) and/or made by known methods. Materials prepared in the examples were analyzed by NMR spectroscopy and were consistent with the given structures.

TABLE 1
Materials Used in the Examples

| Abbreviation | Description and Source |
|---|---|
| nHA | n-hexyl acrylate, obtained from Bimax, Glen Rock, |
| | Pennsylvania |
| THFA | Tetrahydrofuryl acrylate, obtained from TCI America, |
| | Portland, Oregon |
| IBOA | Isobornyl acrylate, obtained from Osaka Chemical |
| | Company, Osaka, Japan |
| HEA | Hydroxylethyl acrylate, obtained from KOWA American |
| | Corporation, New York, New York |
| HPA | Hydroxylpropyl acrylate, obtained from BASF, Charlotte, |
| | North Carolina |
| IOA | Isooctyl acrylate, obtained from Millipore Sigma, |
| | Burlington, Massachusetts |
| EHA | Ethylhexyl acrylate, obtained from BASF, Charlotte, North |
| | Carolina |
| ABP | 4-acryloyloxy benzophenone, prepared according to Temel |
| | et al., Journal of Photochemistry and Photobiology A: |
| | Chemistry, 219, 26-31 (2011) |
| CPI | A mixture of 40% propylene carbonate, 30% p- |
| | thiophenoxyphenyldiphenylsulfonium |
| | hexafluoroantimonate, and 30% bis[4- |
| | (diphenylsulfonio)phenyl]sulfide bis(hexafluoroantimonate), |
| | obtained under the trade designation “CPI 6976” from Aceto |
| | Corporation, Port Washington, New York |
| TINUVIN | 2-(2H-Benzo[d][1,2,3]triazol-2-yl)-6-(2-phenylpropan-2-yl)- |
| 928 | 4-(2,4,4-trimethylpentan-2-yl)phenol, obtained under the |
| | trade designation “TINUVIN 928” from BASF, Charlotte, |
| | North Carolina |
| hexanes | Hexanes, obtained from EMD Millipore Corporation, |
| | Billerica, Massachusetts |
| Boc | Di-tert-butyl dicarbonate, obtained from Millipore Sigma, |
| anhydride | Burlington, Massachusetts |
| DMAP | 4-(dimethylamino)pyridine, obtained from Millipore Sigma, |
| | Burlington, Massachusetts |
| TINUVIN | 2-(benzotriazol-2-yl)-6-dodecyl-4-methyl-phenol, obtained |
| 571 | under the trade designation “TINUVIN 571” from Millipore |
| | Sigma, Burlington, Massachusetts |
| Methanol | Methanol, obtained from VWR Chemicals, Radnor, |
| | Pennsylvania |
| HMPP | 2-hydroxy-2-methylpropiophenone obtained from TCI |
| | America, Portland, Oregon |
| TPO | Diphenyl(2,4,6-trimethylbenzoyl)phosphine oxide, obtained |
| | from IGM Resins USA, Charlotte, North Carolina |

### Test Methods

### Dynamic Mechanical Analysis (DMA) Test Method

A rheometer (TA Instrument, New Castle, DE, USA) was used to measure the tan(delta) (tan(δ)) values in oscillatory shear mode at 70° C. OCA films were stacked to have a thickness of approximately 1 mm and located between parallel plates (8 mm diameter, 1 rad/see frequency).

### Diffusive Transmittance and UV/Vis Optical Properties Test Method

The OCA film was laminated on a 1 mm thick LCD glass substrate (Swift Glass, Elmira Heights, New York) and diffusive transmission was measured by using UltraScan Pro instrument (HunterLab, Reston, VA, USA). UV/Vis spectra were recorded on the OCA films by using Cary 60 UV-Vis Spectrophotometer (Agilent Technologies, Santa Clara, CA, USA).

### Preparatory Examples

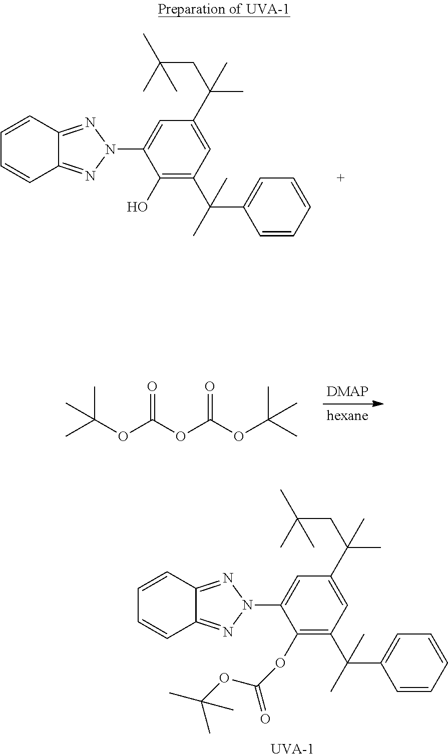

TINUVIN 928, 5.011 g, was dissolved in 11.4 mL of hexanes, ˜0.7 M, in a 100 mL round bottom flask containing a magnetic stir bar and set stirring. Boc anhydride, 3.0101 g, was then added to the flask followed by DMAP, 0.0694 g. A glass stopper was loosely fitted onto the neck. There was evolution of carbon dioxide bubbles and a white precipitate formed as the reaction proceeded. When the reaction was complete after stirring overnight as judged by TLC (Thin-layer chromatography), the mixture was partitioned between ethyl acetate and brine. The organic layer was separate and dried over magnesium sulfate. The organic layer was decanted and concentrated via rotatory evaporation. The resulting white solid was 6.05 g, 98% yield. NMR spectral data corresponds to expected boc protected UV absorber with no detectable phenol.

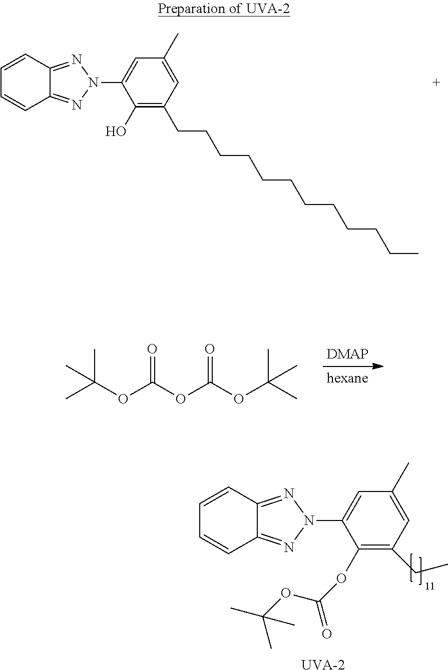

TINUVIN 571, 14.94 g, was dissolved in 28.8 mL of hexanes, ˜0.7M, in a 100 mL round bottom glass flask. The flask contained a magnetic stirrer for mixing. Boc anhydride, 10.08 g, was then added to the flask followed by DMAP, 0.0694 g. A glass stopper was loosely fitted onto the neck. There was evolution of carbon dioxide bubbles and a white precipitate formed as the reaction proceeded. When the reaction was complete after stirring overnight as judged by TLC (Thin-layer chromatography), the mixture was partitioned between ethyl acetate and brine. The organic layer was separate and dried over magnesium sulfate. The organic layer was decanted and concentrated via rotatory evaporation. The resulting amber liquid weighed 17.55 g, for a 93.3% yield. NMR spectral data corresponds to expected boc protected UV absorber with no detectable phenol.

### Preparation of Optically Clear Adhesive (OCA) Films

Base polymer solutions (compositions as listed in Table 2) were prepared using partial UV-polymerization. For example, BASE1 sample was prepared by mixing nHA:THFA:IBOA:HPA at ratios of 40:30:20:10 by weight, followed by addition of HMPP (0.03 pph) in a clear glass jar. This monomer mixture was partially polymerized by UV irradiation using UV-LED (365 nm, ˜5 mW/cm²), which increased the solution viscosity for suitable coating. Next, additional photoinitiators (PI, premixed as 20 wt. % in HEA), photoacid generators (PAGs, premixed as 10 wt. % in THFA) and UV crosslinker (X-linker, premixed as 25 wt. % in IOA) were added to the base polymer solutions as summarized in Table 3 and 5. Additionally, the UVA solutions were prepared by dissolving the UVA-1 in EHA (20 wt. %) or UVA-2 in hot methanol (10 wt. %). These UVA solutions were added to the base polymer solutions as summarized in Table 3 and 5. In the case of UVA-2 containing base polymer solution, methanol was evaporated after mixing under vacuum. The base polymer solution mixture was coated between low-surface energy release liners (siliconized PET films, RF02N and RF22N, available from SKC Hass, Seoul, South Korea) and exposed to UV light (405 nm LED, 8 mW/cm²) for 200 seconds (s). The second stage UV curing step was performed using a Fusion UV Processor (Fusion UV Systems Inc., Gaithersburg, MD) with D-bulb with a target dose of approximately 3,000 mJ/cm² of UV-A wavelength band as measured by a UVI Cure Power Puck 2 (EIT, Sterling, Virginia). Finally, thermal aging was performed by putting the OCA films in an 85° C. convection oven for either 3 hours (h) or 1 h.

TABLE 2
OCA Base Formulation Compositions

| COMPONENT | | |
|---|---|---|
| (% by weight | | |
| except where | FORMULATION | |
| indicated) | BASE1 | BASE2 |
| nHA | 40 | 40 |
| THFA | 30 | 30 |
| IBOA | 20 | 20 |
| HEA | NA | 10 |
| HPA | 10 | NA |
| HMPP (pph) | 0.03 | 0.03 |

### EXAMPLES

### Examples EX-1 To EX-4 and Comparative Examples CE-A to CE-C

Latent UV-absorbing OCA films were prepared by following the above-mentioned procedures with compositions and processing conditions, as summarized in Table 3.

TABLE 3
OCA Films Formulation Compositions and Thermal
Treatment for EX-1 to EX-4 and CE-A to CE-C

| | FORMULATION | | | | | |
|---|---|---|---|---|---|---|
| | Base | PI, | | X-linker, | PAG, | 85° C. |
| SAMPLE | Polymer | pph | UVA, pph | pph | pph | 3 h |
| CE-A | BASE1 | TPO, | — | ABP, 1 | CPI, 1 | 3 h |
| | | 1.6 | | | | |
| EX-1 | BASE1 | TPO, | UVA-2, | ABP, 1 | CPI, 1 | 3 h |
| | | 1.6 | 0.4 | | | |
| EX-2 | BASE1 | TPO, | UVA-2, | ABP, 1 | CPI, 1 | 3 h |
| | | 1.6 | 1 | | | |
| EX-3 | BASE1 | TPO, | UVA-2, | ABP, 1 | CPI, 1 | 3 h |
| | | 1.6 | 2 | | | |
| CE-B | BASE1 | TPO, | TINUVIN | ABP, 1 | CPI, 1 | 3 h |
| | | 1.6 | 571, 2 | | | |
| CE-C | BASE1 | TPO, | UVA-2, | ABP, 0 | CPI, 1 | 3 h |
| | | 1.6 | 1 | | | |
| EX-4 | BASE2 | TPO, | UVA-1, | ABP, 2 | CPI, 1 | 1 h |
| | | 1.6 | 0.8 | | | |

As shown in Table 4, latent UV-absorber-containing OCAs show both a decrease in tan(S), indicating efficient crosslinking, and high UV absorption (see examples: EX-2 and EX-3). However, when non-latent UV absorber is used (CE-B), the tan(S) does not significantly change because the ABP UV crosslinker cannot be activated by the applied irradiation. In another comparative example, CE-C shows that there is no tan(δ) change in the absence of the UV-crosslinker, implying the significance of the synergistic effect of having both latent UV-absorber and UV-crosslinker to achieve the desired effect. Finally, the EX-4 demonstrates that similar molecular structure of base UV absorber (UVA-1) can provide similar performance if the phenol group of the UVA is protected by Boc group.

TABLE 4
Results of Dynamic Mechanical Analysis and Optical Properties
of OCA films with Various UV Absorbers and Photocrosslinkers
for EX-1 to EX-4 and CE-A to CE-C

| | tan(δ) | | | UV |
|---|---|---|---|---|
| | BEFORE | AFTER | tan(δ) | BLOCKING |
| SAMPLE | UV CURE | UV CURE | CHANGE | at 360 nm |
| CE-A | 0.6 | 0.18 | 0.42 | 36 |
| EX-1 | 0.59 | 0.19 | 0.41 | 83 |
| EX-2 | 0.64 | 0.20 | 0.44 | 94 |
| EX-3 | 0.68 | 0.21 | 0.47 | 96 |
| CE-B | 0.69 | 0.56 | 0.12 | 96 |
| CE-C | 0.65 | 0.57 | 0.08 | 94 |
| EX-4 | 0.72 | 0.14 | 0.58 | 83 |

### Examples EX-2, 5 and Comparative Example CE-D

Latent UV-absorbing OCA films were prepared by following the procedures in Preparatory Examples section with varying the concentration of PAG, as summarized in Table 5

TABLE 5
OCA Films Formulation Compositions for EX-5 and CE-D

| | FORMULATION | | | | |
|---|---|---|---|---|---|
| SAMPLE | Base Polymer | PI, pph | UVA, pph | X-linker, pph | PAG, pph |
| EX-2 | BASE1 | TPO, 1.6 | UVA-2, 1 | ABP, 1 | CPI, 1 |
| EX-5 | BASE1 | TPO, 1.6 | UVA-2, 1 | ABP, 1 | CPI, 0.5 |
| CE-D | BASE1 | TPO, 1.6 | UVA-2, 1 | ABP, 1 | CPI, 0 |

As shown in Table 6, addition of a PAG plays an important role in generating UVA after UV irradiation and thermal treatment. When there was no PAG in the presence of a latent UVA in OCA films, no UV protecting property was recovered, indicating that photo-acids from PAG is needed to deblock the BOC group and in-situ generate UVA after the activation step. Only when PAG concentration was increased in the case of EX-2 and 5, UV blocking was possible after the above-mentioned second stage UV curing steps.

TABLE 6
Results of Dynamic Mechanical Analysis and Optical Properties of
OCA films with Various PAG Concentrations for EX-2, 5 and CE-D

| | tan(δ) | | | UV |
|---|---|---|---|---|
| | BEFORE UV | AFTER UV | tan(δ) | BLOCKING |
| SAMPLE | CURE | CURE | CHANGE | at 360 nm |
| EX-2 | 0.62 | 0.1 | 0.52 | 94 |
| EX-5 | 0.64 | 0.12 | 0.52 | 92 |
| CE-D | 0.64 | 0.11 | 0.53 | 35 |

All cited references, patents, and patent applications in the above application for letters patent are herein incorporated by reference in their entirety in a consistent manner. In the event of inconsistencies or contradictions between portions of the incorporated references and this application, the information in the preceding description shall control. The preceding description, given in order to enable one of ordinary skill in the art to practice the claimed disclosure, is not to be construed as limiting the scope of the disclosure, which is defined by the claims and all equivalents thereto.

1. A crosslinkable composition comprising:
a (meth)acrylate polymer, wherein the polymer has a glass transition temperature no greater than 30° C.;
a crosslinking agent, the crosslinking agent comprising a photo-active Type II photoinitiator and a polymerizable group selected from the group consisting of (meth)acrylate, allyl, and combinations thereof; and
a UV absorbing material represented by the structure 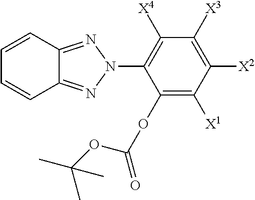
wherein
each of X¹, X², X³, and X⁴ is independently a hydrogen atom, a hydrocarbyl group including 1 to 15 carbon atoms, preferably 12 carbon atoms, or a heterohydrocarbyl group including 1 to 15 carbon atoms, preferably 12 carbon atoms.

2. The crosslinkable composition of claim 1, wherein the composition further comprises an acid generator.

3. An adhesive composition comprising the crosslinkable composition of claim 1.

4. The adhesive composition of claim 3, wherein the adhesive composition is a pressure-sensitive adhesive.

5. An adhesive composition comprising the crosslinkable composition of claim 2.

6. The adhesive composition of claim 5, wherein the adhesive composition is a pressure-sensitive adhesive.
